(19) United States
(12) Patent Application Publication
(10) Pub. No.: US 2023/0158466 A1
(43) Pub. Date: May 25, 2023

(54) METHOD FOR TREATING BIOMASS FOR INJECTION INTO A GASIFICATION REACTOR

(71) Applicant: COMMISSARIAT A L'ENERGIE ATOMIQUE ET AUX ENERGIES ALTERNTIVES, Paris (FR)

(72) Inventors: Hary Demey Cedeno, Grenoble (FR); Thierry Chataing, Grenoble (FR); Muriel Marchand, Grenoble (FR); Gilles Ratel, Grenoble (FR)

(21) Appl. No.: 18/055,606

(22) Filed: Nov. 15, 2022

(30) Foreign Application Priority Data
Nov. 19, 2021 (FR) 2112264

(51) Int. Cl. B01J 13/00; B01J 2/16; C02F 1/28

(52) U.S. Cl. CPC B01J 13/0021; B01J 13/0026; B01J 13/0039; B01J 2/16; C02F 1/286

(57) ABSTRACT

A method for treating biomass to manufacture biomass beads adapted to an implementation in a gasification method, the method comprising the following steps: a) providing a biomass powder, for example a wood bark powder, the particle size of the biomass powder preferably being less than 200 μm, b) providing an alginate solution comprising water and alginate, for example potassium alginate or sodium alginate, c) adding the biomass powder to the alginate solution and mixing, whereby a colloidal suspension is formed, d) dropwise adding the colloidal suspension to an ionotropic coagulation bath comprising multivalent ions, whereby biomass beads are formed.

### CROSS-REFERENCE TO RELATED APPLICATIONS

This application claims priority from French Patent Application No.

2112264 filed on Nov. 19, 2021. The content of this application is incorporated herein by reference in its entirety.

### TECHNICAL FIELD

The present invention generally relates to the field of shaping powders from biomass (raw or treated by thermochemical conversion).

The invention relates to a method for treating biomass and waste to agglomerate the same in the form of “beads”.

The invention also relates to the biomass beads thus obtained.

The invention also relates to a biomass gasification method implementing such beads.

The invention also relates to the use of such beads as adsorbent products implemented in water treatment.

The invention is particularly interesting since it makes it possible to form biomass beads of calibrated diameter and with an aspect ratio close to 1 (almost perfectly spherical shape). These beads have good flow properties and can be stored without risk of explosion or compaction.

The invention finds applications in many industrial fields, in particular for the gasification of biomass (for example dust and other fine carbonaceous waste in industry, for example in the paper industry) or for the depollution/decontamination of water, air and, more generally, gases such as H₂S, a pollutant of methanisation gases.

### STATE OF PRIOR ART

In order to meet the energy dependence on fossil hydrocarbons, one of the most promising solutions is the production of synthesis gas (Syngas) and molecules of interest from biomass and/or carbonaceous waste (resource).

The reclamation of carbonaceous products (biomass and waste) can be performed by a gasification (thermo-conversion) method in an entrained flow reactor (EFR). This method consists in gasifying the resource, typically at temperatures ranging from 900° C. to 1400° C. and pressures ranging from 1 to 30 bar, to obtain a synthesis gas composed essentially of carbon monoxide (CO), dihydrogen (H₂) and carbon dioxide (CO₂). From CO and H₂, it is then possible to obtain hydrocarbon chains CH₂ similar to those from fossil hydrocarbons and thus manufacture a synthetic fuel. The carbon is thus reclaimed as methane or syngas to produce fuels.

The gasification method also allows co-generation of heat and electricity.

Conventionally, before implementing the gasification step, the resource is mechanically pre-treated, through a milling step to adapt the size of the particles to the conveying and injection system of the gasification reactors (typically less than 2 mm). This step is carried out by means of various milling technologies, for example, knife mills, hammer mills, chain mills, etc.

The milling step also leads to the formation of fine particles (<200 μm). Fine powders containing lignocellulosic components are cohesive and elongated, which leads to flow difficulties due to electrostatic attraction (Van der Waals forces) between the reactor walls and the powder. These fine particles, which are generally difficult to convey, also increase ATEX (explosive atmosphere) risks and bring about blockage problems throughout the system, leading to the shut-down of the method.

To avoid these drawbacks, fine particles (<200 μm) are separated from other particles by industrial screening equipment and are generally not or hardly reclaimed.

Yet, the fraction of fines can represent 20 to 50% of the milled material by mass (depending on the milling severity and the friability of the resource).

It is therefore essential to be able to reclaim this fine powder, for example by transforming it into pellets.

In order to be used in a gasification reactor, the pellets should have a diameter of between 200 μm and 3 mm. Fine powders with particle sizes less than 200 μm have blockage problems. Powders greater than 3 mm have low thermo-conversion efficiencies because the residence time of the input in the reactor is short (a few seconds).

Different techniques exist to form pellets from fine particles, in particular wet granulation.

For example, in document FR 3 059 008 A1, pellets are obtained from a wet granulation method for biomass. The method comprises the following steps:

drying the biomass,

milling the biomass,

wet granulating the biomass in the presence of a binder, in particular starch, whereby wet pellets are formed,

drying to obtain dry pellets and, possibly, sieving.

The pellets are then injected into a gasification reactor. Satisfactory results relating to the flowability of the pellets have been obtained. However, this method has some drawbacks: the particle size of the pellets is not homogeneous, hence the implementation of a sieving step (sieve size: 900 μm), and a drying step is necessary (spreading the pellets in thin layers and then oven-drying at room temperature for 8 hours), which makes the method more complex. In addition, the pellets disintegrate easily, which represents a problem for transport and conveying thereof in gasification facilities.

In other technical fields, in particular in the food and pharmaceutical industries, encapsulation methods exist for forming beads with a liquid core/gelling agent shell structure. For example, in document FR 2964017 A1, the method comprises the following steps:

separately conveying in a double envelope, a first liquid solution containing the first product (active principle) and a second liquid solution containing a liquid polyelectrolyte to be gelled, for example alginate,

forming a series of drops, each comprising a central core containing the active principle and a peripheral film completely covering the central core,

contacting the drop, formed in a gas volume at the outlet of the double envelope, with a gelling solution.

immersing each drop in a gelling solution containing a reagent capable of reacting with the electrolyte of the film.

The capsules obtained contain a liquid core and a gelled outer surface. Yet, such capsules are fragile (poor mechanical strength over time). In addition, they have a high moisture content (typically above 80% m) and therefore cannot be used to obtain a good energy efficiency in a gasification reactor of the entrained flow reactor (EFR) type.

In addition, beads produced by this method are sub-millimetre in size (particle size less than 500 μm). A drying step of these beads implies a reduction in particle size (syneresis effect of the gels), which can become less than 200 μm, this is not adapted to a gasification facility, of the EFR type.

Finally, such a method is a batch manufacturing method, and the gelling bath is not recyclable, which complicates production on an industrial scale.

### DISCLOSURE OF THE INVENTION

One purpose of the present invention is to provide a method for treating biomass leading to the formation of biomass beads having dimensions adapted to an implementation in a gasification method and leading to a good gasification efficiency, the method having to be simple to implement, inexpensive and with low or no environmental impact, including in the context of implementation on an industrial scale.

For this, the present invention provides a method for treating biomass to manufacture beads adapted to an implementation in a gasification method, the method comprising the following steps:

providing a biomass powder, for example a wood bark powder, the particle size of the biomass powder preferably being less than 200 μm,

b) providing an alginate solution comprising water and alginate, for example potassium alginate or sodium alginate,

c) adding the biomass powder to the alginate solution and mixing, whereby a colloidal suspension is formed,

d) dropwise adding the colloidal suspension to an ionotropic coagulation bath comprising multivalent ions, whereby biomass beads are formed.

The invention differs from prior art in particular in the use of alginate to form biomass beads by a wet process. The alginate is mixed with the biomass before being dropwise injected into an ionotropic coagulation bath. This wet granulation leads to the formation of beads of uniform size distribution and calibrated diameter. The beads are formed from a homogeneous mixture of alginate and biomass (in surface and volume).

Such beads are easy to convey and to inject into gasification reactors (for example, entrained flow reactor, EFR). Fine particles are thus reclaimed.

Such beads allow dosing and flowability of powders in a gasification reactor, which contributes to an improvement of the technical management of the method and to a better conversion/reclamation of the biomass.

Alginate is a natural polysaccharide obtained from algae. Alginate has the feature of instantly forming a hydrogel in the presence of multivalent, in particular divalent, ions. The carboxyl groups of alginate have the property of chelating divalent ions of opposite charge (for example Ca²⁺), leading to the formation of rigid three-dimensional networks. This is known as an “ionotropic” hydrogel.

By hydrogel, it is meant a hydrophilic polymeric network that can absorb up to several thousand times its dry mass in water.

Advantageously, the ionotropic coagulation bath is an aqueous calcium nitrate solution.

According to a highly advantageous alternative embodiment, the ionotropic coagulation bath is an aqueous calcium nitrate and potassium nitrate solution. The addition of potassium nitrate to the coagulation bath improves catalytic effects during the gasification method in EFR, thermo-conversion is improved.

Advantageously, the ionotropic coagulation bath has a pH of between 3 and 7.

Advantageously, the alginate/biomass mass ratio of the colloidal suspension is between 0.01% m and 50% m, preferably between 1% m and 10% m, for example 1% m.

Advantageously, step d) is carried out by means of an injection nozzle, preferably having an outlet port of 1 mm to 20 mm in diameter. The use of a nozzle decreases the width of the particle size distribution: there is fewer possible rearrangements between the grains, an increase in porosity and a decrease in compaction. This is of interest for flowability, by reducing bridging/blockage risks.

Advantageously, the method includes a subsequent step e) during which the biomass particles are dried, for example with forced air, preferably at a temperature of between 20° C. and 30° C. This step is particularly advantageous when the beads are used in a dry gasification method.

Advantageously, the method is carried out continuously:

step a) is carried out in a first reactor,

step b) is carried out in a second reactor, the first reactor and the second reactor being in fluid communication with a mixing tank,

step c) is carried out in the mixing tank, in fluid communication with an injection nozzle disposed facing a vessel containing the ionotropic bath, the vessel being advantageously fitted with a pH probe, the vessel being fitted with an outlet disposed facing an element fitted with a multitude of openings, configured to discharge the beads towards a drying device and allowing a liquid phase to be recovered through the openings, the liquid phase being advantageously reinjected into the vessel.

This continuous method is simple to implement and the various elements of the facility are easy to use. The whole method can be carried out at room temperature (typically at a temperature of between 20 and 25° C.) and at ambient pressure (typically at a pressure of 1 bar).

The method has many advantages, in particular one or more of the following:

the fine biomass powder is homogeneously distributed within the beads,

beads of micrometric size (typically greater than 50 μm and preferably greater than 200 μm) and preferably of millimetric size are obtained, which limits problems associated with handling and conveying fine powders: blockages, health risks (in particular cancers associated with wood powders or risk of Alzheimer's disease and/or lung disease) and ATEX (risk of explosion related to powders . . . ),

the surface state of the beads is modified: the beads are smoother, which reduces powder-powder and powder-wall friction, thus avoiding blockages/bridges/consolidations,

the particle interaction mechanisms (electrostatic forces, Van der Walls forces . . . ) depending on the size of the particles are modified; this leads to an improvement in the flowability of fine particles,

the agglomeration of the beads does not require any external intervention (the phenomenon occurs on its own) and the energy expenditure related to this agglomeration is zero,

there is no strong consolidation within the beads (which facilitates disintegration in the reactor): the bead can be easily destroyed in EFR where the residence times are short because the particles are not strongly compacted,

the properties of the particles are not modified by the agglomeration mechanism and once released, they have the same behaviour in gasification as if they had not been agglomerated into beads.

The invention also relates to biomass beads adapted to an implementation in a gasification method. The biomass beads, obtained from the previously described method, are rigid.

Advantageously, the biomass bead comprises a homogeneous mixture of alginate and biomass. Preferably the biomass is wood bark.

The composition of the bead is homogeneous in surface and volume. The resulting beads do not have a core/shell structure. The alginate and the biomass powder are found throughout the volume of the bead.

Advantageously, the aspect ratio of the bead is close to 1 (almost perfectly spherical shape). This considerably reduces the conveying problems due to the interaction between the beads because of their morphology (asperities promoting attachment but also possibilities of rearrangements of grains in the voids).

Advantageously, the bead has a diameter of between 1 mm and 20 mm.

The beads may further contain inorganic species (calcium and, preferably, potassium) that promote gasification kinetics by catalytic effect.

The biomass beads thus obtained have many properties: ease of storage and handling, better flowability.

The invention also relates to a gasification method comprising a step during which biomass beads as previously defined are gasified in a gasification reactor, in particular an entrained flow gasification reactor.

The biomass beads may be raw, torrefied, pyrolysed or carbonised.

The use of such beads facilitates the implementation of the gasification method (and in particular the conveying and injection steps) compared to methods using fine biomass powders or biomass pastes and thus increases the efficiency of the gasification method.

It allows gasification of fine biomass powders (particle size <200 μm) transformed into biomass beads (size between 200 μm and 3 mm for example) and thus increases the efficiency since all powders can be gasified.

The natural binder itself from the biomass is easily volatilised in the reactor: the bead can disintegrate over a few seconds in EFR and the fine particles are released and gasified; the binder itself can contribute to the gasification efficiency.

The alginate may have an impact on the morphology and structure of the wall of the formed beads, which may promote the penetration of reactive gases during gasification.

The beads contain less sulphur in proportion to the raw biomass powder, which reduces catalyst poisoning phenomena during gasification.

The invention also relates to the use of biomass beads, as previously defined, for example wood bark beads, as adsorbent products implemented in water treatment. The beads form a filter medium for the adsorption of pollutants in liquid effluents. They can also form a filter medium for the adsorption of pollutants in gaseous effluents.

An increase in the porosity of the bed can promote interaction between the fluid to be treated and the filter medium. If the particles are too imbricated, there is a risk that the fluid will not flow properly through the filter medium.

Further characteristics and advantages of the invention will become apparent from the following further description.

It goes without saying that this further description is only given as an illustration of the object of the invention and should in no way be construed as a limitation of that object.

### BRIEF DESCRIPTION OF THE DRAWINGS

The present invention will be better understood upon reading the description of examples of embodiments given purely for indicative and in no way limiting purposes, with reference to the appended drawings in which:

FIG. 1 represents a protocol for manufacturing biomass beads according to a particular embodiment of the invention.

FIG. 2 schematically represents a pilot line for continuously producing beads (capacity: 100 kg/h), according to another particular embodiment of the invention.

FIGS. 3A and 3B are photographic pictures representing wet biomass beads produced from a wood bark powder, according to another particular embodiment of the invention.

FIGS. 4A and 4B are photographic pictures representing ionotropic coagulation baths containing wet biomass beads produced from a wood bark powder, according to another particular embodiment of the invention.

FIG. 5A is a graph representing the particle size distribution of the fine wood bark powder.

FIG. 5B is a graph representing the size distribution of the bark beads, obtained from a fine wood bark powder, according to another particular embodiment of the invention.

FIG. 6A is a photographic picture representing particles of a fine biomass powder.

FIG. 6B is a photographic picture representing wet beads produced from the wood bark powder, represented in FIG. 6A, according to another particular embodiment of the invention.

FIG. 6C is a photographic picture representing dry beads produced from the wood bark powder, represented in FIG. 6A, according to another particular embodiment of the invention.

FIG. 7 schematically represents an avalanche angle.

FIGS. 8A, 8B and 8C represent avalanche angles of a biomass powder.

FIGS. 8D, 8E and 8F represent avalanche angles of glass beads.

FIGS. 8G, 8H and 81 represent avalanche angles of biomass beads, according to a particular embodiment of the invention.

FIG. 9 is a scanning electron microscope picture of a biomass bead, according to a particular embodiment of the invention.

FIGS. 10A and 10B are scanning electron microscope pictures of the interior of a biomass bead, according to a particular embodiment of the invention.

FIG. 11 is a graph representing the mass percentage and temperature versus time for gasification tests on a wood bark powder and wood bark biomass beads obtained according to a particular embodiment of the invention.

The various parts represented in the figures are not necessarily to a uniform scale, to make the figures more legible.

The various possibilities (alternatives and embodiments) are to be understood as not being exclusive of each other and may be combined with each other.

Furthermore, in the description hereinafter, orientation-dependent terms such as “top”, “bottom”, etc. of a device apply when considering that the structure is oriented as illustrated in the figures.

### DETAILED DISCLOSURE OF PARTICULAR EMBODIMENTS

In the following, although the description refers to biomass from the forestry and agricultural industry, the invention is transposable to other types of biomass, for example food waste, household waste, agricultural waste, micro-plastics, nanoparticles, fine particles from industrial processes, carbon black, sewage sludge, etc. It can also relate to raw materials or materials resulting from the thermochemical conversion of biomass, for example fine particles resulting from a carbonisation method. The invention is interesting for recovering dust and other small-sized waste (typically less than 200 μm), facilitating their storage and discharge (for example, quench bath or cyclone in gasification reactor, sawmills etc.).

Although this is by no means limiting, the invention particularly finds applications to reclaim fine wood bark powders.

The method for treating biomass comprises the following steps (FIG. 1):

providing a biomass powder,

b) providing an alginate solution comprising water and alginate, for example potassium alginate or sodium alginate,

c) adding the biomass powder to the alginate solution and mixing, whereby a colloidal suspension is formed,

d) dropwise adding the colloidal suspension to an ionotropic coagulation bath comprising multivalent ions, whereby biomass beads are formed.

e) optionally drying the biomass particles, for example with forced air, preferably at a temperature of between 20° C. and 30° C.

The biomass powder provided in step a) comprises biomass particles. The particle size is preferably less than 1000 μm, more preferably less than 200 μm. The particle size is for example between 1 nm and 1000 μm, preferably between 10 nm and 200 μm.

Within the context of this invention, the term biomass implies any material (homogeneous and inhomogeneous) of plant and/or animal origin containing carbon, such as the biomass of forestry and agricultural residues, household waste, tyre waste, carbon black, sewage sludge, animal bone waste, etc. All these resources can be dry or wet.

Biomass can also refer to biomass treated by different thermo-conversion methods, such as for example torrefaction, pyrolysis, hydrothermal carbonisation, hydrothermal liquefaction and/or carbonaceous residues. For example, the term biomass also refers to biochar (pyrolysis), biocoals (torrefaction), hydrochars (hydrothermal carbonisation) and chars (gasification).

The biomass powder is preferably a wood bark powder.

The alginate solution provided in step b) is for example a solution containing an alginate mass content ranging from 0.01% m to 50% m, preferably from 1% m to 10% m. Preferably, the alginate is sodium alginate: this is an inexpensive and widely available reagent.

Step c) is for example carried out under magnetic stirring. The speed of rotation of the mixture as well as the duration of the mixing will be chosen by the person skilled in the art. Step c) is carried out until a homogeneous mixture is obtained.

The ionotropic coagulation bath (also called spherification bath) is an aqueous solution. The solution contains multivalent ions (preferably divalent ions) that can react with the alginate to form a polymer. For example, these may be copper, cadmium, barium, calcium, cobalt, nickel, iron, zinc or manganese ions.

Calcium ions are preferably chosen. These ions are non-toxic and their use does not require an additional purification step compared to other ions.

The ionotropic coagulation bath is, for example, a solution of calcium chloride and/or calcium nitrate.

According to another preferred alternative embodiment, the ionotropic coagulation bath contains both calcium ions and potassium ions. The potassium ions have the property of catalysing the gasification reaction.

The coagulation bath is, for example, a solution of divalent ion nitrate and/or divalent ion chloride. Different divalent ion nitrates and/or different divalent ion chlorides may be used in a same solution.

Advantageously, a solution comprising one or more divalent ion nitrates is chosen. Many ions can be associated with nitrates.

Preferably, the ionotropic coagulation bath is an aqueous calcium nitrate solution, which may further comprise potassium nitrate.

Preferably, the ionotropic coagulation bath has a pH of between 3 and 7. For example, a pH of 4 is chosen.

The ionotropic bath may also comprise substances to impart special properties to the beads, for example colorants, flame accelerators and/or inhibitors agents, etc.

The ionotropic bath may contain species chelating multivalent ions, in particular calcium ions.

The alginate/biomass mass ratio of the colloidal suspension is between 0.01% m and 50% m, preferably between 1% m and 10% m, for example 1% m.

Step d) is carried out by means of an injection nozzle, preferably having an outlet port of 1 mm to 20 mm in diameter. For example, a diameter of 3 mm is chosen.

The drying step e) is advantageously carried out in air at room temperature (typically 20 to 25° C.). There is no energy input. Forced air can be used. For example, wet beads of 3 mm in diameter have a diameter of 1.45 mm after drying.

Advantageously, the entire method is carried out at room temperature.

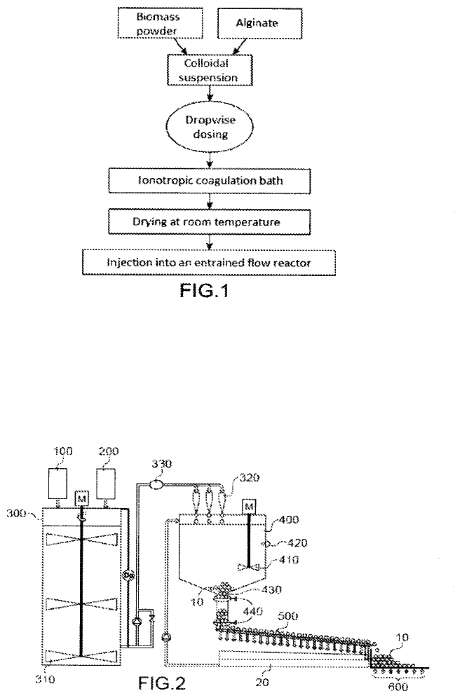

According to a particularly advantageous embodiment, the method is carried out continuously. For example, the continuous method is carried out using the biomass bead production line represented in FIG. 2. Such a facility allows up to 100 kg/h of beads to be obtained.

Step a) is carried out in a first reactor 100.

Step b) is carried out in a second reactor 200.

The first reactor and the second reactor are in fluid communication with a mixing tank 300, fitted with a mixer 310.

Step c) is carried out in the mixing tank 300.

The mixing tank 300 is in fluid communication with one or more injection nozzles 320 disposed facing a vessel 400 containing the ionotropic coagulation bath.

A flow meter 330 may be used to control the flow rate at the nozzle(s) 320.

The vessel 400 is advantageously fitted with a mixing device 410 and/or a pH probe 420. The pH probe 420 in particular makes it possible to determine whether the amount of divalent ions is still sufficient.

The beads 10 fall by gravity to the bottom of the vessel 400.

Advantageously, the vessel 400 is fitted with an outlet 430 disposed facing a recovery element 500.

For example, a double guillotine system 440 disposed at the bottom of the vessel allows a fraction of the volume of the vessel 400 formed by a liquid phase 20 and a solid phase (beads 10) to be discharged.

The recovery element 500 is fitted with a multitude of openings. The dimensions of the openings are smaller than the dimensions of the beads 10. The liquid phase passes through the openings. The solid elements (beads 10) are routed to a drying device 600, for example.

The recovery element 500 may be an inclined tray or a conveyor belt.

The drying device 600 operates for example with forced air.

Advantageously, the liquid phase 20 is re-injected into the vessel 400.

The beads obtained with the previously described method comprise a homogeneous mixture of alginate and biomass.

Preferably, the beads comprise a homogeneous mixture of calcium alginate and biomass. According to another preferred embodiment, the beads comprise a homogeneous mixture of calcium and potassium alginate and biomass.

The beads have a diameter of between 1 mm and 20 mm, for example 3 mm.

The aspect ratio of the bead is advantageously close to 1.

By aspect ratio close to 1, it is meant that the ratio of the width to the height (or of the largest dimension to the smallest dimension) of the beads formed by this method is close to 1, that is, it does not vary by more than 10% and preferably it does not vary by more than 5% with respect to the value 1. An aspect ratio close to 1 means that the beads are spherical in shape.

The beads obtained are rigid materials, stable over time (several years, for example between 1 and 5 years).

The beads can then be reclaimed in a gasification method. The biomass powders can be used raw or torrefied.

The gasification method is implemented in a gasification reactor, in particular an entrained flow gasification reactor.

The gasification method can be carried out continuously in a facility comprising a gasification reactor, for example an entrained flow gasification reactor, and upstream thereof a biomass bead production line for implementing the method for treating biomass.

Alternatively, the beads can be used as adsorbent products implemented in various treatments of liquid or gaseous effluents (such as, for example, elimination of H₂S from the biomethane production method by anaerobic digestion). In particular, it can be the treatment of aqueous effluents, for example industrial water. For example, the beads enable all or part of certain elements present in the aqueous effluents to be adsorbed. By way of illustration, lead, zinc or nickel can be mentioned. Water purification methods for removing mineral particles from polluted water can also be mentioned. After a first step of removing particles by filtration or centrifugation, the fine particles can advantageously be collected and then eliminated by the method of the invention.

The water is thus decontaminated/depolluted.

Illustrative and non-limiting examples of an embodiment:

Laboratory Production of the Beads:

In this example, 40 g of biomass powder (particle size less than 100 μm) has been added to a solution comprising 10 g of alginate and 990 mL of water.

The colloidal suspension thus obtained has been mixed for 30 min at 300 rpm.

The colloidal suspension has then been added dropwise to an ionotropic coagulation bath (10 g Ca(NO₃)₂ and 990 mL water).

Biomass beads are thus obtained. The beads are dried at room temperature (20-25° C.). The beads can then be injected into an entrained flow gasification reactor.

Production of beads on an industrial scale:

According to another example, biomass “beads” (<200 μm) have been prepared in three steps on a pilot line (FIGS. 1 and 2):

step 1: One litre of sodium alginate solution (1% m) is prepared by dissolving 10 kg of sodium alginate in 990 kg of water in a reactor 200. The mixture is mechanically stirred at 300 rpm for 1 h (to obtain a fully homogenised solution). Then, a mass of biomass powder ranging from 1-100 kg (particle size <200 μm) is mixed with the alginate solution under stirring (at 300 rpm) for 1 h in a mixing tank 300.

step 2: The flow rate of the injection of the mixture of alginate and biomass powder into the vessel 400 containing the ionotropic coagulation bath (containing 10 kg of calcium nitrate and 10 kg of potassium nitrate dissolved in 980 kg of water) is controlled by a peristaltic pump 330 (flow rate 1 m³/h). At the outlet of the pump 330, a system of nozzles 320 of diameter (Ø3 mm) has been installed, which allows dosing of regular sized drops into the ionotropic coagulation bath. The desired bead diameter can be set and controlled according to the diameter of the nozzles (typically from 1 mm to 20 mm, preferably 3 mm).

step 3: The beads formed in the ionotropic bath have a residence time of more than 30 min, and are then collected and air dried (at 22° C.) for 5 to 10 h. The water from the ionotropic bath is recycled to the system and the pH is monitored. The initial pH of the bath is above pH 3 and below pH 7.

The beads 10 are sampled through a lock 440 positioned at the foot of the coagulation bath with gravity dewatering on a perforated tray 500 with recovery and reinjection of the collected water 20 into the bath and collection and drying by air circulation of the beads 10.

The ionotropic bath in the vessel 400 as well as the colloidal alginate/biomass powder suspension in the mixing tank 300 are homogenised using a stirrer 410, 310 equipped with blades.

The water level in the mixing tank 300 is monitored to continuously adjust the dosage of the biomass powder and alginate.

During the bead formation method, the pH of the bath gradually increases. Monitoring the change of the pH of the ionotropic coagulation bath is carried out with a pH probe 420 (to define its renewal when the coagulation efficiency collapses and impacts the quality of the beads), as well as periodic sampling to quantify by ion chromatography the concentration of residual calcium ions present in the bath, as a function of time. The initial pH of the bath is above pH 3.0 and below pH 7.0. During the bead formation method, the pH of the bath increases gradually, if the pH 7.0, the addition of 10 kg of calcium nitrate and 10 kg of potassium nitrate is necessary.

Characterisation of Bead Dimensions:

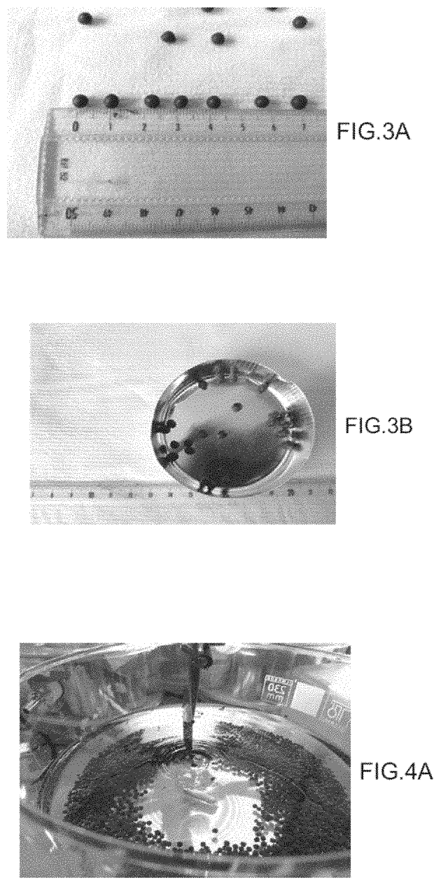

The average diameter of the beads at the end of the laboratory method was Ø3 mm (FIGS. 3A and 3B). However, this diameter can be set and controlled according to the diameter of the nozzles used in the manufacturing method (typically from 1 mm to 20 mm, preferably 3 mm).

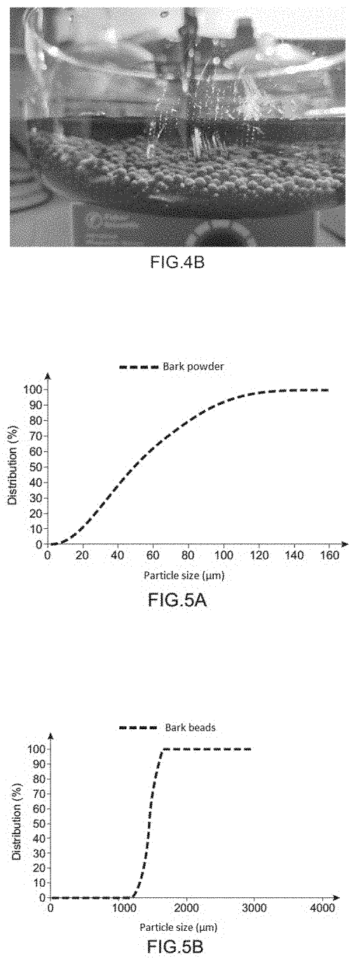

The pilot scale example has enabled the repeatability of the results obtained (FIGS. 4A and 4B) to be checked, the beads are uniform and homogeneous (Ø3 mm). The wet beads have been air dried (without any energy input to the system). The size of the dry beads is 1.45 mm which is half the size of the wet beads.

The size of the dry beads corresponds to the optimal particle size for injection into an EFR reactor, however this size can be set according to the diameter of the nozzles used during manufacture (typically from 1 mm to 20 mm, preferably 3 mm).

The particle size distribution of the fine wood bark powder and air-dried beads has been checked using a CAMSIZER XT particle analyser (manufacturer: Retsch Technology).

FIGS. 5A and 5B show that the average diameter (d50) of the powder samples is 48.9 μm and for the dried beads 1445 μm, that is, a factor of 30 compared to the fine powder. The particle size distribution of the beads is less spread out than that of the fine wood bark powder, indicating a monodisperse distribution for the beads (less spread out).

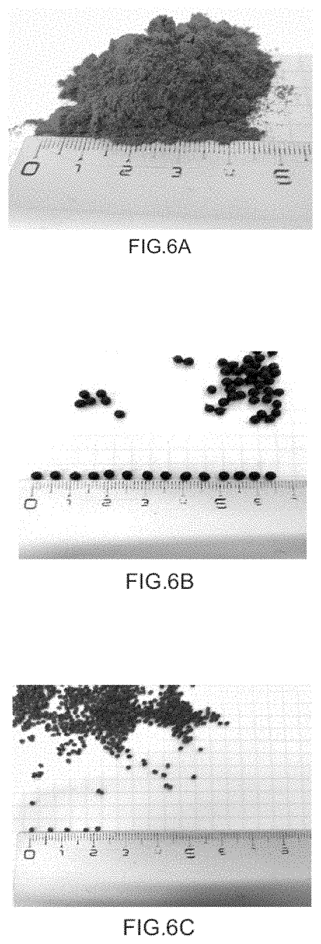

It has also been checked that the drying step enables the particle size to be reduced by a factor of 2 compared to the freshly produced wet beads (FIGS. 6A, 6B and 6C).

Bead Composition:

The results of the characterisation of the beads and the biomass powder (in particular wood bark) are set out in the following Table 1. The bead formation process does not modify the carbon content or the gross calorific value (GCV) of the final product compared to the powder (17 MJ/kg). However, the manufacturing method may slightly increase the ash content in the order of 2% m, due to the presence of divalent ions in the ionotropic bath.

It should be noted that the percentage of sulphur present in the beads is less than that of biomass powder, which is particularly interesting when the gasification method is carried out in the presence of a catalyst.

TABLE 1
Elemental analyses.

| | | | | | | | Gross |
|---|---|---|---|---|---|---|---|
| Elemental analyses | | | | | | Ash | calorific |
| | C | H | N | S | O | content | value |
| Biomass | (%) | (%) | (%) | (%) | (%) | (%) | (MJkg⁻¹) |
| Bark powder | 42.2 | 5.42 | 0.72 | 0.29 | 40.9 | 9.84 | 17.0 |
| Bark powder | 42.7 | 5.71 | 0.72 | 0.18 | 39.5 | 11.87 | 16.9 |
| beads | | | | | | | |

Cohesivity Tests (Avalanche Angle):

The cohesivity tests have been carried out using a rotating drum (REVOLUTION, manufacturer: Mercury Scientific Inc., USA) equipped with an adapted camera which allows determination of the average avalanche angle of the samples. The avalanche angle represents the ability of a free powder (in the absence of mechanical stresses other than its own weight) to consolidate. The closer the angle is to zero, the more the powder “collapses” and spreads on itself. The closer this angle is to 90°, the more the powder tends to form arches and bridges that impede its flow (highly cohesive powder)

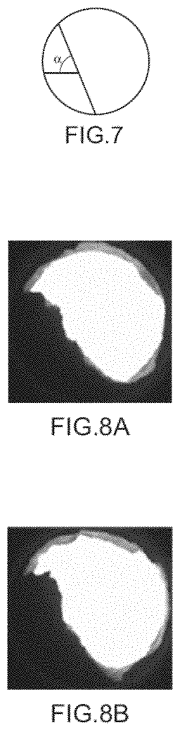

The avalanche angle is determined by the angle that the upper half of the powder surface in the drum forms with the horizontal, before an avalanche (FIG. 7).

Measurements of avalanche angles have been made for:

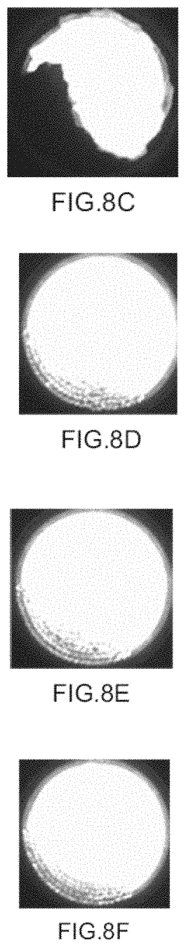

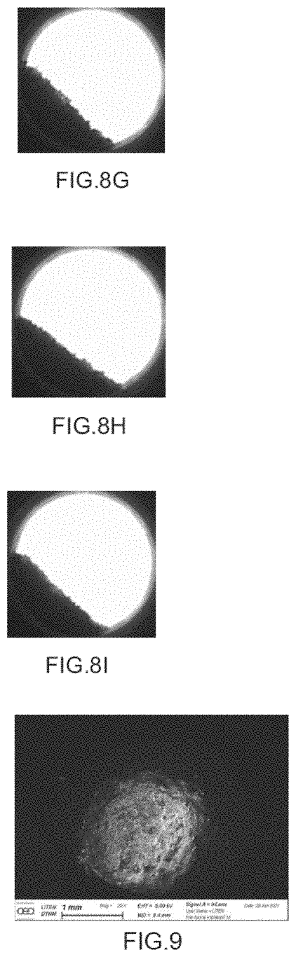

a biomass powder (particle size <200 μm) (FIG. 8A, 8B and 8C),

glass beads with a diameter of 3 mm (FIGS. 8D, 8E and 8F),

a biomass powder produced according to the invention (Ø3 mm) (FIGS. 8G, 8H and 8I).

The average angle results over 1000 avalanches are listed in the following table 2.

The biomass powder (particle size <200 μm) has a high cohesivity resulting in a high avalanche angle (87.7°). This value is also an indicator of possible blockage/conveying problems frequently found in gasification methods. Indeed, a high cohesivity leads to a low flowability of the powder, that is, a low ability to flow under stress, for example in an injector.

The “spherification” procedure improves the flowability of the powder for injection into an entrained flow reactor. The bark beads have an avalanche angle half that of the powder, resulting in improved flowability. The avalanche angle of the biomass beads) (40.3° is close to the values obtained with the glass beads(39.2°) and shows evidence of the interest of the method to improve the injection in EFR.

TABLE 2
Avalanche angle (average over 1000 avalanches).

| | Bark powder | Glass beads | Bark powder |
|---|---|---|---|
| | (<200 μm) | (Ø 3 mm) | beads (Ø 3 mm) |
| Avalanche angle | 87.7° | 39.2° | 40.3° |

Moisture content:

Measurements of moisture content of air-dried beads at room temperature (22° C., for 10 h) have been carried out in a laboratory oven at 105° C. (for 24 h) following the EN18134 standard. The results confirm a residual moisture content of 1.2% m.

It should be noted that the initial moisture content of the freshly prepared beads (which have not undergone a drying step) is 90% m. The air-drying step is effective in volatilising almost all of the water present in the beads, which saves energy costs in the preparation method and allows better management of the resource for injection into gasification reactors.

Surface Morphology of the Beads:

Scanning electron microscope (SEM) images have been taken to check the surface structure of the biomass beads. The analyses confirm a rigid and compact structure (FIG. 9). The biomass powder is distributed over the entire surface of the bead, and the alginate-based biopolymer functions as a link that facilitates the spherical agglomeration of the biomass powder.

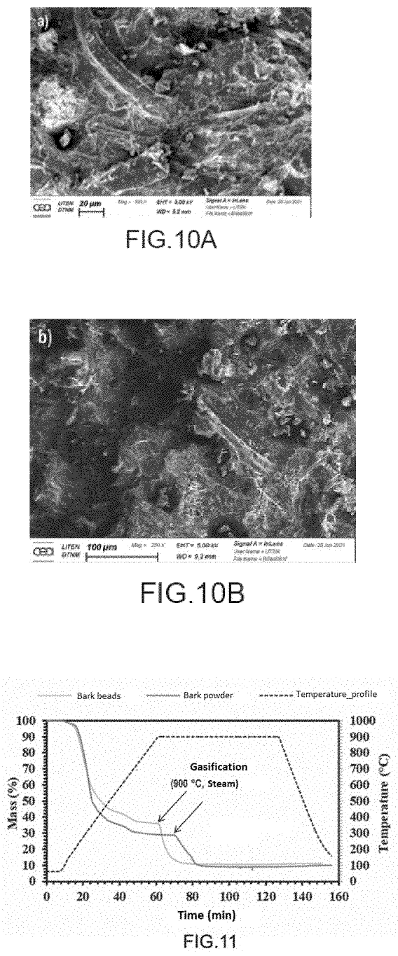

The morphology within the beads has also been observed under the microscope (by cutting a bead into two halves, using a scalpel). The images in FIGS. 10A and 10B show a homogeneous surface inside the bead, confirming a total distribution of the biomass powder in the volume of the spheres.

Gasification Tests:

Steam gasification tests have been performed in an ATG thermo-conversion device (SETSYS, manufacturer SETARAM, France), using biomass powder (in particular wood bark powder: particle size <200 μm) and biomass beads (in particular wood bark beads: particle size Ø3 mm). For performing these tests, the ATG device has been heated at a rate of 10° C./min to 900° C. Once this temperature is reached, thermochemical gasification is carried out by injecting steam for a period of 70 min.

FIG. 11 sets out the results of mass loss versus temperature during the gasification process. The gasification results of the beads (containing calcium and potassium ions from the production method) have a steeper ramp and faster conversion kinetics than those of the raw biomass powder. This is due to the catalytic effect of calcium and potassium ions on the process.

The bead production method improves the flowability of the biomass powder as well as its thermo-conversion kinetics in a gasification reactor (for example, entrained flow reactor).

1. A method for treating biomass to manufacture biomass beads adapted to an implementation in a gasification method, the method comprising the following steps:
a) providing a biomass powder,
b) providing an alginate solution comprising water and alginate,
c) adding the biomass powder to the alginate solution and mixing, whereby a colloidal suspension is formed,
d) dropwise adding the colloidal suspension to an ionotropic coagulation bath comprising divalent ions, whereby biomass beads adapted to an implementation in a gasification method are formed.

2. The method according to claim 1, wherein the ionotropic coagulation bath is an aqueous solution of calcium nitrate.

3. The method according to claim 1, wherein the ionotropic coagulation bath contains calcium ions and potassium ions.

4. The method according to claim 1, wherein the ionotropic coagulation bath is an aqueous solution of calcium nitrate and potassium nitrate.

5. The method according to claim 1, wherein the method includes a subsequent step e) during which the biomass beads are dried.

6. The method according to claim 5, wherein the biomass beads are dried with forced air, at a temperature of between 20° C. and 30° C.

7. The method according to claim 1, wherein the ionotropic coagulation bath has a pH of between 3 and 7.

8. The method according to claim 1, wherein the alginate/biomass mass ratio of the colloidal suspension is between 0.01% m and 50% m.

9. The method according to claim 8, wherein the alginate/biomass mass ratio of the colloidal suspension is between 1% m and 10% m.

10. The method according to claim 1, wherein step d) is carried out by means of an injection nozzle having an outlet port of 1 mm to 20 mm in diameter.

11. The method according to claim 1, wherein the particle size of the biomass powder is less than 1000 μm.

12. The method according to claim 1, wherein the particle size of the biomass powder is less than 200 μm.

13. The method according to claim 1, wherein the biomass powder provided in step a) is a wood bark powder.

14. The method according to claim 1, wherein the method is carried out continuously,
step a) being carried out in a first reactor,
step b) being carried out in a second reactor,
the first reactor and the second reactor being in fluid communication with a mixing tank,
step c) being carried out in the mixing tank, in fluid communication with an injection nozzle disposed facing a vessel containing the ionotropic bath,
the vessel being fitted with an outlet disposed facing an element fitted with a multitude of openings, configured to discharge the beads towards a drying device and allowing a liquid phase to be recovered through the openings.

15. The method according to claim 14, wherein the liquid phase recovered through the openings is reinjected into the vessel.

16. A biomass bead adapted to an implementation in a gasification method and obtained according to the method according to claim 1, comprising a homogeneous mixture of alginate and biomass.

17. The bead according to claim 16, wherein it has a diameter of between 1 mm and 20 mm and wherein the aspect ratio of the bead is close to 1.

18. The bead according to claim 16, wherein the biomass is wood bark.

19. A gasification method comprising a step during which biomass beads as defined in claim 16 are gasified in a gasification reactor.

20. A use of biomass beads, as defined in claim 16, as adsorbent products implemented in water treatment.
